(19) United States
(12) Patent Application Publication
(10) Pub. No.: US 2018/0278995 A1
(43) Pub. Date: Sep. 27, 2018

(54) INFORMATION PROCESSING APPARATUS, INFORMATION PROCESSING METHOD, AND PROGRAM

(71) Applicant: SONY CORPORATION, Tokyo (JP)

(72) Inventor: Kei TAKAHASHI, Tokyo (JP)

(73) Assignee: SONY CORPORATION, Tokyo (JP)

(21) Appl. No.: 15/918,499

(22) Filed: Mar. 12, 2018

(30) Foreign Application Priority Data
Mar. 24, 2017 (JP) 2017-059511

(51) Int. Cl. H04N 21/442; H04N 21/4223; H04N 21/431; H04N 21/4788; H04N 21/218

(52) U.S. Cl. CPC H04N 21/44218; H04N 21/4223; H04N 21/21805; H04N 21/4788; H04N 21/4312

(57) ABSTRACT

A data processing unit, on the basis of a first viewing region of a first user when the first user inputs a comment with respect to delivered content, sets guidance information that guides a second user viewing a second viewing region to the first viewing region, the guidance information being set in the second viewing region. A control unit controls an output apparatus of the second user to display the second viewing region in which the guidance information is set.

### CROSS REFERENCE TO RELATED APPLICATIONS

This application claims the benefit of Japanese Priority Patent Application JP 2017-059511 filed Mar. 24, 2017, the entire contents of which are incorporated herein by reference.

### BACKGROUND

The present disclosure relates to an information processing apparatus, an information processing method, and a program. More particularly, the present disclosure relates to an information processing apparatus, an information processing method, and a program that overlay comments by users viewing network-delivered content onto the content.

Recently, the delivery and viewing of content over networks such as the Internet is flourishing. Also, recently, an increasing number of services provide free viewpoint video in which the viewpoint direction is changeable, such as multi-viewpoint video captured with a multi-viewpoint camera including multiple cameras, omnidirectional video captured with an omnidirectional camera, or panoramic video, for example.

For example, a head-mounted display used by being worn on the head can be used to view free viewpoint video. For example, a proposal has been made regarding a head-mounted display system provided with an imaging subsystem that captures a wide-angle image of wider angle than a display image which is actually displayed, and on the basis of position information regarding the user's head detected by a rotational angle sensor, the display image that the user should see is cut out and displayed (for example, see JP H8-191419A).

Also, by applying bidirectional communication to a free viewpoint video delivery service, an interactive viewing service can be realized. For example, video in which the viewpoint position and viewpoint direction has been switched for each user can be delivered, and a variety of needs can be met (for example, see JP 2013-255210A).

Free viewpoint video can be utilized as content related to entertainment such as sports, games, concerts, and drama, for example. Also, through bidirectional communication between the capturing site and the viewer, it is also possible to provide instruction, teaching, guidance, and assistance to the videographer, who captures a still/moving image, from the viewer of the content.

Furthermore, there is also widespread usage of systems that enable many users to communicate while viewing the same content by overlaying comments by the users viewing content delivered over a network onto the content.

### SUMMARY

In an embodiment of the present disclosure, for example, it is desirable to provide an information processing apparatus, an information processing method, and a program in which, in a system that overlays comments by users viewing network-delivered content onto the content, information indicating a comment together with a viewing region of a user and the like is transmitted, and a viewing user other than the comment transmitter is able to immediately view the viewing region of the comment transmitter.

Furthermore, in an embodiment of the present disclosure, it is desirable to provide an information processing apparatus, an information processing method, and a program in which a user viewing network-delivered content is able to switch between the two modes of a comment-input enabled mode in which comment input is enabled, and a comment-input disabled mode in which comment input is disabled.

A first embodiment of the present disclosure is an information processing apparatus. The information processing apparatus includes a data processing unit and a control unit. The data processing unit is configured to control a display of content delivered over a network. The control unit is configured to control an output apparatus configured to display at least a part of the content. The data processing unit, on a basis of a first viewing region of a first user when the first user inputs a comment with respect to the delivered content, sets guidance information that guides a second user viewing a second viewing region of the delivered content different from the first viewing region to the first viewing region, the guidance information being set in the second viewing region. The control unit controls the output apparatus of the second user to display the second viewing region in which the guidance information is set.

A second embodiment of the present disclosure is an information processing method including: controlling a display of content delivered over a network; controlling an output apparatus configured to display at least a part of the content; setting, on a basis of a viewing region indicating a first viewing region of a first user when the first user inputs a comment with respect to the delivered content, guidance information that guides a second user viewing a second viewing region of the delivered content different from the first viewing region to the first viewing region, the guidance information being set in the second viewing region; and controlling the output apparatus of the second user to display the second viewing region in which the guidance information is set.

A third embodiment of the present disclosure is a storage medium containing a program that causes information processing to be executed in an information processing apparatus, the program including: an instruction of controlling an output apparatus configured to display at least a part of content delivered over a network; an instruction of setting, on a basis of a viewing region indicating a first viewing region of a first user when the first user inputs a comment with respect to the delivered content, guidance information that guides a second user viewing a second viewing region of the delivered content different from the first viewing region to the first viewing region, the guidance information being set in the second viewing region; and an instruction of controlling the output apparatus of the second user to display the second viewing region in which the guidance information is set.

Note that a program according to an embodiment of the present disclosure is, for example, a program provided in computer-readable format to an information processing apparatus or a computer system capable of executing various program code, the program being providable by a storage medium or communication medium. By providing such a program in a computer-readable format, processing corresponding to the program is performed on the information processing apparatus or the computer system.

Further objectives, features, and advantages of the present disclosure will be clarified by a more detailed description based on the embodiments of the present disclosure described hereinafter and the attached drawings. Note that in this specification, the term “system” refers to a logical aggregate configuration of multiple devices, and the respective devices of the configuration are not limited to being inside the same housing.

According to the configuration of an embodiment of the present disclosure, there is realized a configuration in which guidance information for guiding one to a viewing region of a comment-inputting user is displayed overlaid onto content, thereby enabling many content-viewing users to view a specific image region. Note that the advantageous effects described in this specification are merely for the sake of example and non-limiting, and there may be additional advantageous effects.

### BRIEF DESCRIPTION OF THE DRAWINGS

FIG. 1 is a diagram illustrating an exemplary configuration of an information processing system 100;

FIG. 2 is a diagram illustrating an exemplary configuration of a content-providing apparatus 101;

FIG. 3 is a diagram illustrating an exemplary configuration of a content-outputting apparatus 102;

FIG. 4 is a diagram illustrating a sequence of a content delivery process;

FIG. 5 is a diagram illustrating an example of display information displayed on the content-outputting apparatus:

FIG. 6 is a diagram explaining a sequence of content delivery process that overlays comments;

FIG. 7 is a diagram explaining a sequence of content delivery process that overlays comments;

FIG. 8 is a diagram illustrating an example of display information displayed on the content-outputting apparatus;

FIG. 9 is a diagram illustrating an example of display information displayed on the content-outputting apparatus;

FIG. 10 is a diagram illustrating an example of display information displayed on the content-outputting apparatus:

FIG. 11 is a diagram explaining a configuration enabling switching between comment-input enabled/disabled modes:

FIG. 12 is a diagram illustrating an example of display information displayed on the content-outputting apparatus:

FIG. 13 is a diagram illustrating an example of display information displayed on the content-outputting apparatus;

FIG. 14 is a diagram illustrating an example of display information displayed on the content-outputting apparatus:

FIG. 15 is a diagram illustrating an example of display information displayed on the content-outputting apparatus; and

FIG. 16 is a diagram explaining an exemplary hardware configuration of an information processing apparatus.

### DETAILED DESCRIPTION OF THE EMBODIMENT(S)

Hereinafter, the details of an information processing apparatus, an information processing method, and a program of an embodiment of the present disclosure will be described with reference to the drawings. Note that the following items will be described.

1. Exemplary configuration of information processing system

2. Exemplary configuration of content-providing apparatus and content-outputting apparatus

3. Sequences of content capturing, transmission, and viewing processes

4. Exemplary process of outputting comments by content-viewing users together with content

5. Configuration of content-outputting apparatus enabling switching between comment-input enabled mode and comment-input disabled mode

6. Exemplary hardware configuration of information processing apparatus

7. Summary of configuration according to embodiment of present disclosure

### [1. Exemplary Configuration of Information Processing System]

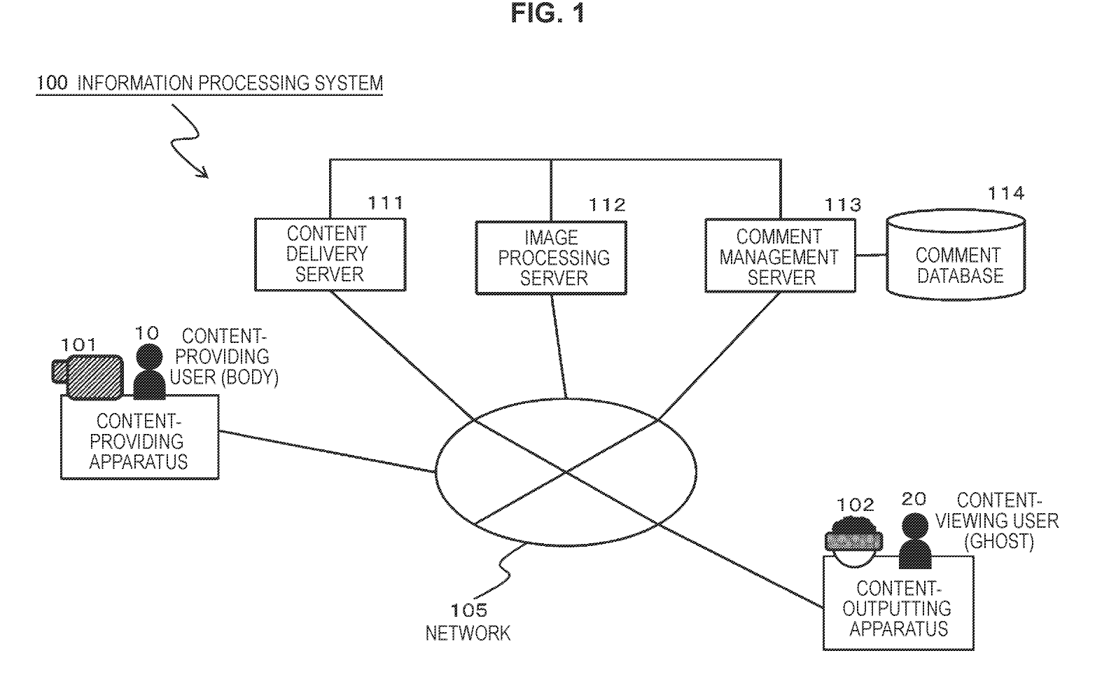

FIG. 1 is a diagram illustrating an exemplary configuration of the information processing system 100 utilizing an information processing apparatus according to an embodiment of the present disclosure. Specifically, for example, the information processing system 100 is configured as a free viewpoint video delivery system or an omnidirectional video delivery system.

Image information, such as free viewpoint video or omnidirectional video acquired using a content-providing apparatus 101 (for example, an imaging apparatus such as a multi-viewpoint camera or an omnidirectional camera), is transmitted to a content delivery server 111 over a network 105, and additionally transmitted from the content delivery server 111 to a content-outputting apparatus 102. Note that free viewpoint video may be considered to be content enabling a content-viewing user to view video from an arbitrary viewpoint. On the other hand, omnidirectional video may be considered to be video in which, although a content-viewing user is able to view substantially in all directions, movement of the viewpoint of the content-viewing user is more limited than with free viewpoint video. The content-outputting apparatus 102 is able to display content on a display unit of the content-providing apparatus 101. Note that although FIG. 1 illustrates only one each of the content-providing apparatus 101 and the content-outputting apparatus 102, large numbers of these apparatus exist on the network. Also, although free viewpoint video is mainly described in the following, the configuration according to an embodiment of the present disclosure may also be applied to omnidirectional video.

In other words, numerous content-providing apparatus 101 which act as the suppliers of captured image information exist at various positions, and transmit content including images, audio, and the like captured at various positions. Additionally, numerous content-outputting apparatus 102 also exist at various positions on the network, and many viewing users are able to view content at the same time.

It is sufficient for the content-providing apparatus 101 to be able to acquire captured image information in a space where, for example, a content videographer who uses an imaging apparatus, namely a content-providing user (Body) 10, exists. Any of various types of apparatus configurations may be adopted for the content-providing apparatus 101.

For example, in addition to typical camera apparatus, multi-viewpoint cameras, and omnidirectional cameras, the content-providing apparatus 101 may also take the form of a wearable device worn by a videographer, like a head-mounted display provided with an imaging section such as a camera or an imager.

Note that a user who performs a content acquisition process using a content-providing apparatus 101 is called a content-providing user (Body) 10. Meanwhile, a user who views content acquired by a content-providing user (Body) is called a content-viewing user (Ghost) 20.

A videographer who acts as a content-providing user 10 is called a Body because that person is engaged in activity with one's own body at the actual site of capturing (that is, one's body is physical present at the site). Note that a videographer is anticipated to be not only a person (natural person), but also mobile apparatus such as vehicles (including vehicles driven manually by a person as well as vehicles which drive automatically or which are unmanned), boats, aircraft, robots, and drones.

On the other hand, a user who is not actually present at the site of capturing, and who views content displayed through the screen of a head-mounted display, for example, is called a Ghost. The content-viewing user (Ghost) 20 is not engaged in activity with one's own body at the site, but is able to have consciousness of the site by viewing video seen from the viewpoint of a content-providing user, namely a videographer. In this way, a content-viewing user is called a Ghost because only that person's consciousness is present at the site. The terms Body and Ghost are terms for distinguishing each user.

Note that the space where the content-providing user (Body) 10 exists is basically a real space, but can also be defined as a virtual space instead of a real space. Hereinafter, “real space” or “virtual space” will be simply designated “space” in some cases. Also, captured image information acquired by the content-providing apparatus 101 can also be called content information associated with the space of the content-providing user 10. Hereinafter, captured image information acquired by the content-providing apparatus 101 is also called “content”.

The present embodiment anticipates that numerous videographers acting as content-providing users 10 each go to a point of interest (POI; a place someone thinks is convenient or interesting), and perform capturing work there using each of the content-providing apparatus 101.

Examples of a POI referred to herein may include a tourist attraction, a commercial facility or each shop inside a commercial facility, a stadium where a sports competition such as baseball or soccer takes place, a hall, a concert venue, a theater, and the like. However, the capturing location is not limited to a POI or the like.

The content delivery server 111 streams content in real-time (live video) transmitted from each content-providing apparatus 101 to each viewer of free viewpoint video over the network 105. Alternatively, content stored in a content database is delivered to each viewer of free viewpoint video over the network 105.

The content-viewing user (Ghost) 20 views content acquired by the content-providing apparatus 101 via the content-outputting apparatus 102. The content-outputting apparatus 102 is configured by a head-mounted-display, for example, by a combination of a PC and a head-mounted display, for example, or the like. The content-outputting apparatus 102 is an apparatus enabling the viewing of virtual reality (VR) video, for example. Output apparatus include smartphones and tablets.

For example, the content-outputting apparatus 102 such as a head-mounted display includes an on-board stereo camera and 9 degrees of freedom (9DoF) sensor or the like, and is capable of localization. Also, the content-outputting apparatus 102 such as a head-mounted display is assumed to be able to detect the gaze of the viewer, namely the content-viewing user, by using a pupil-corneal reflection method or the like, and from the rotational center positions of the left and right eyes and the facing of the visual axis (as well as the head attitude), compute the gaze direction of the content-viewing user. Alternatively, the forward direction may be treated as the gaze direction of the content-viewing user, on the basis of measurement by head tracking using a gyro or the like, or the estimated attitude of the head.

For example, in the case in which the content-outputting apparatus 102 is configured by a PC and a head-mounted display, the head-mounted display acquires a self-position and a gaze direction, and transmits the acquired information successively to the PC. The PC receives a content stream of free viewpoint video from the content delivery server 111 over the network 105. Additionally, the PC renders free viewpoint video with the self-position received from the head-mounted display and a prescribed field of view (FoV). Subsequently, the rendering result is displayed on the display of the head-mounted display. The viewer, by changing the attitude of one's own head, is able to freely control the viewpoint position and the gaze direction.

Note that a configuration can also be taken in which the process of rendering free viewpoint video based on the self-position and the gaze direction of the viewer is performed inside the head-mounted display rather than on the PC. Also, a configuration can be taken in which the head-mounted display connects directly to the network 105, without going through the PC. Alternatively, instead of using a head-mounted display, rendered free viewpoint video may be displayed on a monitor or display provided with respect to the PC or a smartphone, and viewed by the viewer.

Furthermore, on the screen of the content-outputting apparatus 102, for example, a user interface (UI) including recommendation information including a list of content captured by the numerous content-providing apparatus 101 or the like may be displayed, and the content-viewing user 20 may select content through an operation on the UI screen. A variety of layouts are possible as the screen layout of the UI that displays the recommendation information. For example, the layout may be a list of titles or thumbnails of representative images of the content, a display of the capturing locations of the free viewpoint video (the locations where the content-providing apparatus 101 are installed, or the locations where the content-providing users are present), or a list of user names (including nicknames or handle names) or thumbnails of face images of the videographers, namely the content-providing users.

In this specification, the framework of interaction when the content-viewing user 20 views content acquired on the content-providing user 10 side is also called “JackIn (connection)”. The content-viewing user 20 is able to view content associated with the space of the connected content-providing user 10. When connected to the content-viewing user 20, the content-providing user can also be said to deliver content associated with one's own space.

Users connect to each other for a variety of objectives. For example, besides the objective of simply viewing content associated with a space where oneself is not present or content one is interested in (for example, watching sports captured on the content-providing user 10 side), in some cases, the content-viewing user 20 may connect to the content-providing user 10 with the objective of providing teaching or assistance to the content-providing user 10.

Furthermore, the content-viewing user 20 is able to input comments with respect to content that is being viewed. Note that the region of content where the content-viewing user 20 inputs comments may be called the first viewing region in some cases. Comments are input by a process such as speech input through a microphone provided on the content-outputting apparatus 102, or by input through a keyboard.

Comments input into the content-outputting apparatus 102 can be communicated to numerous users viewing the same content over the network 105. Comments are displayed overlaid as text data onto the content displayed on the display unit, for example.

The comment management server 113 illustrated in FIG. 1 acquires comment data transmitted from the content-outputting apparatus 102, and stores the comment data in a comment database 114. Note that, although details will be described later, the content-outputting apparatus 102 transmits comments to the comment management server 113 together with viewing region information from when the comments are input.

Furthermore, the comments and the viewing region information from when the comments are input are forwarded from the comment management server 113 to an image processing server 112. The image processing server 112, on the basis of the viewing region information from when the comments are input, generates content set with guidance information for guiding a content-viewing user (second user) other than the comment inputter to the viewing region (first viewing region) of the comment-inputting user (first user). Note that the region being viewed by the content-viewing user other than the comment inputter may be called the second viewing region in some cases. After that, the content generated by the image processing server 112 is transmitted over the network 105 to the numerous content-outputting apparatus 102, and to the content-providing apparatus 101 which are the active subjects that provide content. Specific examples and details of processes corresponding to comments will be described in a later section.

### [2. Exemplary Configuration of Content-Providing Apparatus and Content-Outputting Apparatus]

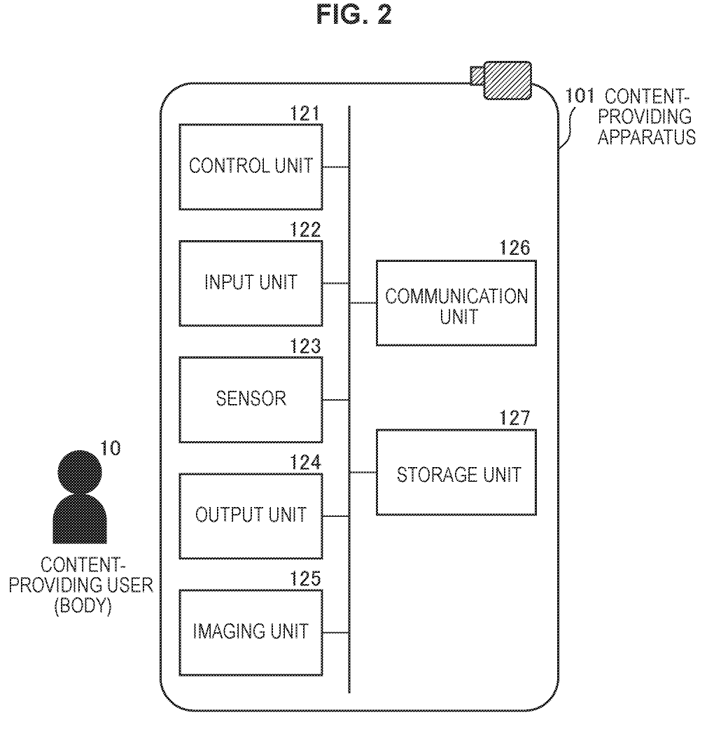

Next, an exemplary configuration of the content-providing apparatus 101 and the content-outputting apparatus 102 will be described with reference to FIG. 2 and the subsequent drawings.

FIG. 2 illustrates an exemplary configuration of the content-providing apparatus 101. The content-providing apparatus 101 includes a control unit 121, an input unit 122, a sensor 123, an output unit 124, an imaging unit 125, a communication unit 126, and a storage unit 127.

The control unit 121 controls various processes executed in the content-providing apparatus 101. For example, control is executed in accordance with a program stored in the storage unit 127. The input unit 122 includes the input of operation information by the user, an audio input unit (microphone) that inputs audio information, and the like. The audio input unit may be either a monaural microphone or a stereo microphone, and picks up the voice of the content-providing user during capturing, sounds produced by the subject being captured with the content-providing apparatus 101, and the like.

The sensor 123 is a sensor that detects the conditions around the content-providing user, and includes various types of environment sensors that detect information related to the weather of the space where the content-providing user 10 is present (or during capturing), such as the temperature, humidity, atmospheric pressure, and luminous intensity. In addition, the sensor 123 may also include biological sensors that detect biological information about the videographer, such as body temperature, pulse, perspiration, respiration, and brain waves. Furthermore, the sensor 123 may also be provided with an imaging apparatus other than the content-providing apparatus 101 that captures the videographer, namely the content-providing user oneself and companions of the videographer, and acquires information about the user oneself or information about the companions through processes such as face detection and face recognition.

Additionally, the sensor 123 may also include a position sensor that measures the current position of the content-providing apparatus 101 or the content-providing user 10. The position sensor, for example, receives Global Navigation Satellite System (GNSS) signals from GNSS satellites (for example, Global Positioning System (GPS) signals from GPS satellites) to execute positioning, and generates position information including the latitude, longitude, and altitude of a vehicle. Alternatively, the position sensor may specify the current position on the basis of signal strength information from wireless access points by utilizing PlaceEngine (registered trademark).

The information detected by the sensor 123 can be treated as information associated with the space of the content-providing user 10, and can also be treated as information associated with an acquisition period of content.

In the space where the content-providing apparatus 101 or the content-providing user 10 is present, there is provided an output unit 124 capable of presenting information to the videographer, namely the content-providing user 10, via video display, audio output, and the like. On a display screen provided in the output unit 124, a UI including recommendation information containing a list of content delivery destinations (content-viewing users requesting access to the content) or the like may be displayed, and the content-providing user 10 may select a content delivery destination through an operation on the UI screen.

In addition, besides video and audio output, the output unit 124 may also be provided with a configuration for producing output such as vibration, mild electric shock, or haptic (tactile) feedback. Furthermore, the output unit 124 may also include a device capable of supporting or restricting at least part of the limbs of the content-providing user 10, and instructing the content-providing user 10 about actions to perform, like an exoskeleton device. The output unit 124 can be utilized to provide information feedback from a viewer of content, namely the content-viewing user side, and to provide instruction and assistance from the content-viewing user 20 to the content-providing user 10.

The imaging unit 125 is an imaging unit that takes images. The communication unit 126 is connected to the network 105, and transmits AV content, which includes the content acquired by the content-providing apparatus 101 and audio during imaging picked up by the input unit 122, and also receives information to be output by the output unit 124. Additionally, the communication unit 126 may also transmit environmental information or the like measured by the sensor 123. Also, the communication unit 126 is able to receive an access request with respect to content (or a connection request) from the content-viewing user 20, either directly, or indirectly via the content delivery server 111.

The storage unit 127 is utilized as a storage area for the programs of processes executed in the control unit 121 and the like, captured images, and the like, for example. Furthermore, the storage unit 127 is also utilized as a work area or the like for parameters used in various processing, and for a variety of processes.

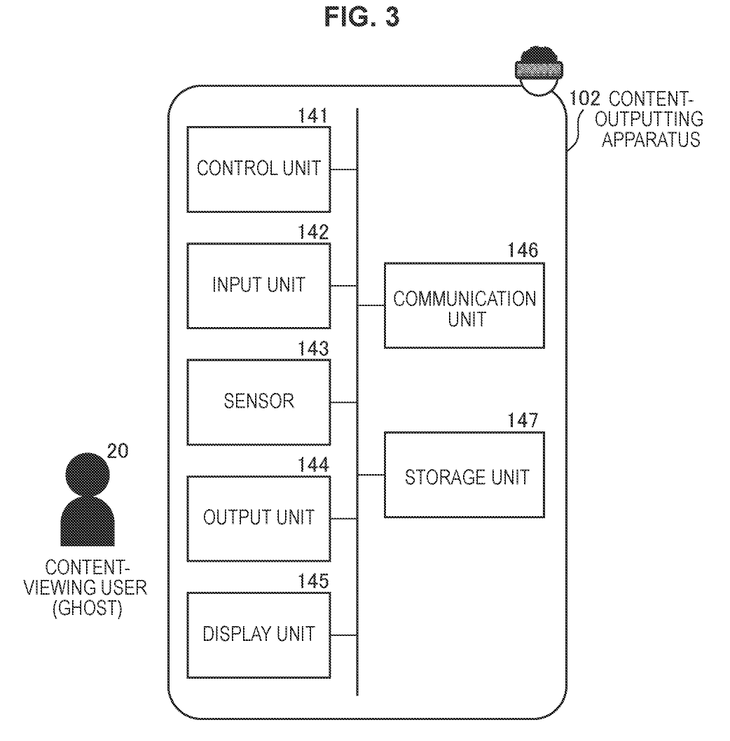

FIG. 3 illustrates an exemplary configuration of the content-outputting apparatus 102. Basically, the content-outputting apparatus 102 is used for the display of content acquired on the content-providing user 10 side as a videographer (or for viewing by the content-viewing user 20). The content-outputting apparatus 102 is provided with a UI function in addition to a content display function, and is assumed to be capable of displaying information related to the content recommended by the content delivery server 111 and enabling a content selection operation by the content-viewing user 20, for example.

As illustrated in FIG. 3, the content-outputting apparatus 102 includes a control unit 141, an input unit 142, a sensor 143, an output unit 144, a display unit 145, a communication unit 146, and a storage unit 147. The control unit 141 controls processes executed in the content-outputting apparatus 102. For example, control is executed in accordance with a program stored in the storage unit 147.

The input unit 142 includes various devices, such as audio input unit (microphone) for inputting audio information, a camera that captures the content-viewing user and one's companions, an input device such as a keyboard, and a coordinate input device such as a mouse or a touch panel. For example, speech, textual information, coordinate information, and the like produced by the content-viewing user and one's companions while viewing free viewpoint video is acquired via the input unit 142.

Note that the input unit 142 may also include input devices of a type used by being worn on the body of a viewer, like gloves or clothing, such as a type enabling the movements of the fingertips and torso to be input directly, for example. The content-viewing user 20 viewing content in real-time is able to use the input unit 142 to input instructions (such as assistance) with respect to the videographer of the content, namely the content-providing user 10. When at least part of the input information acquired by the input unit 142 is transmitted to the content-providing apparatus 101 side, in the space of the content-providing user 10, instructions from the content-viewing user 20 are output by the output unit 124.

Also, in the space where the content-outputting apparatus 102 or the content-viewing user 20 is present, there is provided a sensor 143 that detects the conditions around the content-viewing user 20 for whom the viewing environment or the like changes dynamically. The sensor 143 includes various types of environment sensors that detect information related to the weather of the space where the content-viewing user 20 is present (or during content viewing), such as the temperature, humidity, atmospheric pressure, and luminous intensity. In addition, the sensor 143 may also include biological sensors that detect biological information about the viewer, such as body temperature, pulse, perspiration, respiration, and brain waves. Furthermore, the sensor 143 may be provided with an imaging apparatus that captures the viewer, namely the content-viewing user 20 oneself and one's companions, and may be configured to acquire information about the user oneself and the companions by performing processes such as face detection and face recognition on the captured image.

Additionally, the sensor 143 may also include a position sensor that measures the current position of the content-outputting apparatus 102 or the content-viewing user 20. The position sensor, for example, receives GNSS signals from GNSS satellites to execute positioning, and generates position information including the latitude, longitude, and altitude of a vehicle. Alternatively, the position sensor may specify the current position on the basis of signal strength information from wireless access points by utilizing PlaceEngine (registered trademark).

The information detected by the sensor 143 can be treated as information associated with the space of the content-viewing user 20. Additionally, during the period in which received content is being displayed by the content-outputting apparatus 102, or during the period in which the content-viewing user 20 is viewing the content, sensor information detected by the sensor 143 can also be treated as information associated with a viewing period of content.

Additionally, in the space where the content-outputting apparatus 102 or the content-viewing user 20 is present, an output unit 144 is provided. The output unit 144 performs a process of outputting audio and the like. For example, besides audio, the output unit 144 preferably takes a configuration that outputs environmental information for creating a variety of viewing environments. For example, the output unit 144 is a section of controlling the environment of the space of the content-viewing user 20 (or a multi-modal interface) that adjusts the temperature and humidity, blows wind (a breeze, a head wind, or an air blast) and sprays water (a water blast) onto the viewer, applies tactile feedback (such as an effect of poking the viewer in the back, or a sensation as though something is touching the viewer's neck or feet) or vibration, imparts a mild electric shock, and emits an odor or fragrance.

The output unit 144 is driven on the basis of the environmental information measured by the sensor 123 on the content-providing apparatus 101 side, for example, giving the viewer a realistic and immersive experience like at the capturing location. Additionally, the output unit 144 may also be driven on the basis of a result of analyzing the content to be displayed by the content-outputting apparatus 102, and impart effects to the content-viewing user 20 viewing the content.

Also, the output unit 144 is assumed to be provided with an audio output device such as speakers, and to output an audio signal seamlessly with the video stream, such as audio of the subject picked up at the capturing site where the content is acquired (or the space of the content-providing user 10), and speech emitted by the content-providing user 10 during capturing. The audio output device may also include multi-channel speakers, and may be capable of sound localization.

The display unit 145 is utilized to display content, display a user interface (UI), and the like. The communication unit 146 transmits information over the network 105. For example, the communication unit 146 is able to transmit an access request with respect to the content-providing user 10 or the content, either directly to the content-providing apparatus 101, or indirectly via the content delivery server 111.

Also, the communication unit 146 is able to transmit input information input into the input unit 142 while the content-viewing user 20 is viewing video to the content-providing apparatus 101 side over the network 105. Additionally, the communication unit 146 is able to receive output information over the network 105, and output to the content-viewing user 20 from the output unit 144.

The storage unit 147 is utilized as a storage area for the programs of processes executed in the control unit 141 and the like, and parameters used in various processing, for example. The storage unit 147 furthermore is utilized as a work area or the like for a variety of processes.

[3. Sequences of Content Capturing, Transmission, and Viewing Processes]

Next, sequences of content capturing, transmission, and viewing processes executed using the information processing system 100 illustrated in FIG. 1 will be described.

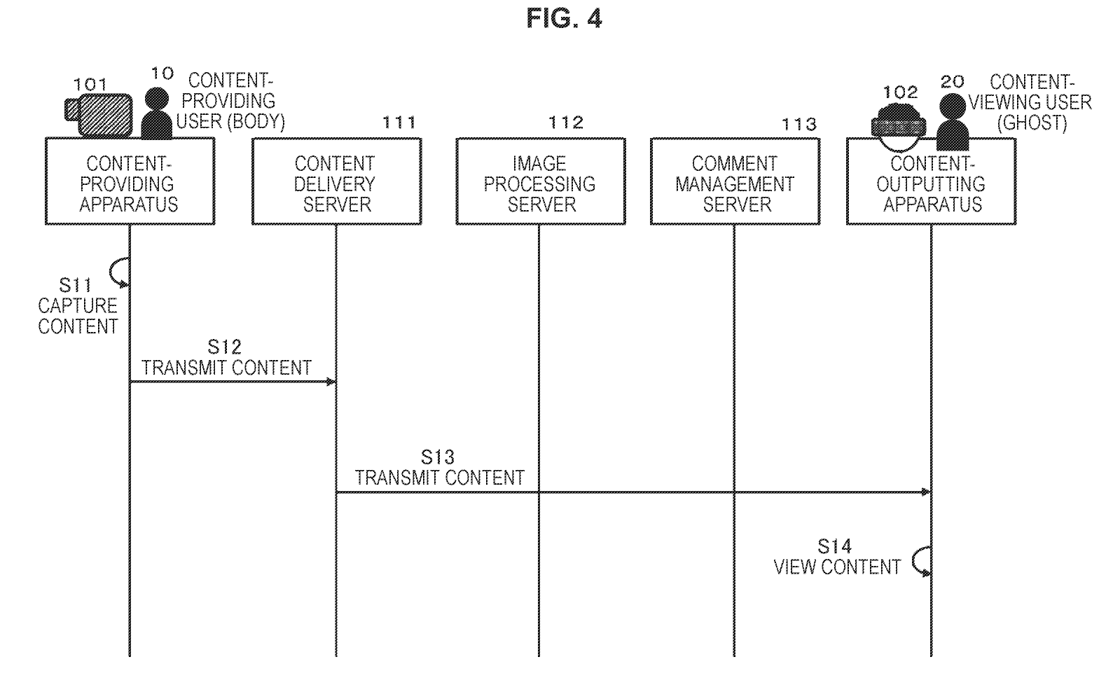

FIG. 4 is a sequence diagram explaining sequences of content capturing, transmission, and viewing processes.

FIG. 4 illustrates, from the left, the content-providing apparatus 101, the content delivery server 111, the image processing server 112, the comment management server 113, and the content-outputting apparatus 102 illustrated in FIG.

1. Each of these elements performs a communication process over the network 105.

First, in step S11, the content-providing apparatus 101 captures content. The content is free viewpoint video content, for example. The content-providing apparatus 101 is provided with an imaging unit such as a multi-viewpoint camera or an omnidirectional camera, and captures free viewpoint video content.

In step S12, the content captured by the content-providing apparatus 101 is transmitted to the content delivery server 111 over the network 105.

The content delivery server 111 transmits the content received from the content-providing apparatus 101 to the content-outputting apparatus 102 over the network 105. Note that although FIG. 4 illustrates only a single content-outputting apparatus 102, numerous content-outputting apparatus 102 exist on the network 105, and the content provided by the content-providing apparatus 101 is transmitted to numerous content-outputting apparatus 102, and is viewed by numerous content-viewing users 20.

In step S14, the content-outputting apparatus 102 displays received content on a display unit, and the content-viewing user 20 views the displayed content. Note that, as described earlier, the content-outputting apparatus 102 is configured by a head-mounted-display, for example, by a combination of a PC and a head-mounted display, for example, or the like. The content-outputting apparatus 102 is an apparatus enabling the viewing of virtual reality (VR) video, for example.

As described earlier, the content-outputting apparatus 102 such as a head-mounted display detects the gaze of the viewer, namely the content-viewing user, by using a head tracking process, a pupil-corneal reflection method, or the like, for example, and from the rotational center positions of the left and right eyes and the facing of the visual axis (as well as the head attitude), computes the gaze direction of the content-viewing user, and displays an image in the gaze direction on the display unit. In other words, by altering one's gaze direction, the content-viewing user 20 is able to view images in various directions.

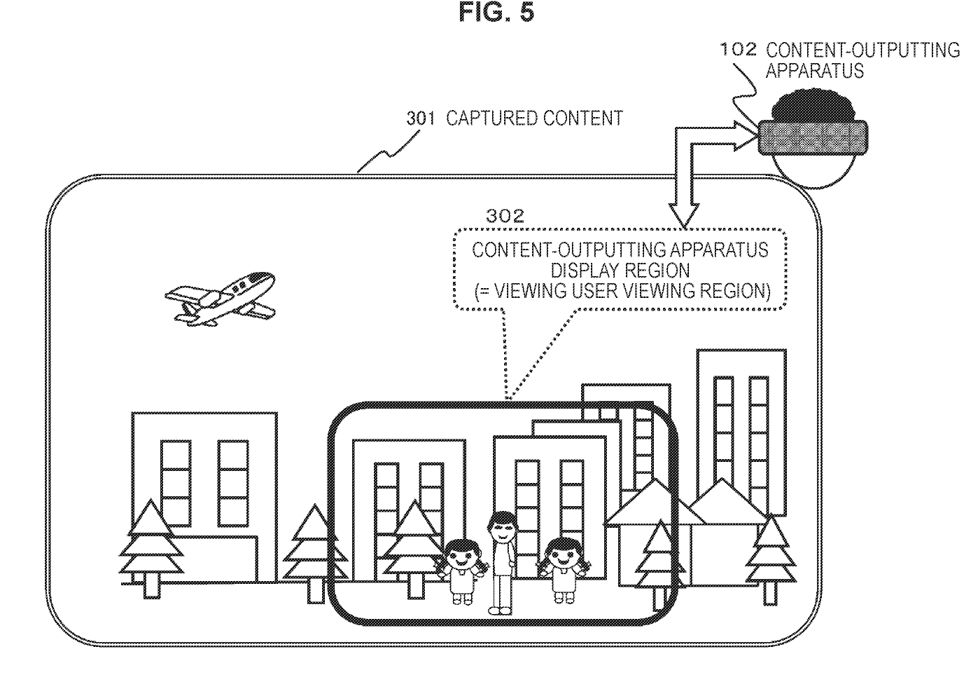

FIG. 5 will be referenced to describe an example of free viewpoint video content captured in the content-providing apparatus 101, and a display image of the content-outputting apparatus 102. FIG. 5 illustrates captured content 301. The captured content 301 is free viewpoint video content captured in the content-providing apparatus 101.

A content-outputting apparatus display region 302 illustrated as a partial region inside the captured content 301 illustrated in FIG. 5 is an example of an image displayed on the display unit of the content-outputting apparatus 102. The content-outputting apparatus display region 302 is the image region being viewed by the content-viewing user 20, but by the content-viewing user 20 changing the direction of one's head or one's gaze direction, it is possible to view other image regions of the captured content 301. In other words, the content-outputting apparatus display region 302 illustrated in FIG. 5 can be moved freely by the content-viewing user 20 changing the direction of one's head or one's gaze direction, making it possible to observe all image regions of the captured content 301.

The processes described with reference to FIGS. 4 and 5 are a typical sequence of free viewpoint video capturing, transmission, and viewing processes. Note that in the example described above, an example in which the delivered content of the content delivery server 111 is taken to be real-time content captured by the content-providing apparatus 101 is described, but the delivered content of the content delivery server 111 may also be recorded content that has been captured in advance and stored in a content database.

[4. Exemplary Process of Outputting Comments by Content-Viewing User Together with Content]

Next, an exemplary process of outputting comments by content-viewing users together with content will be described.

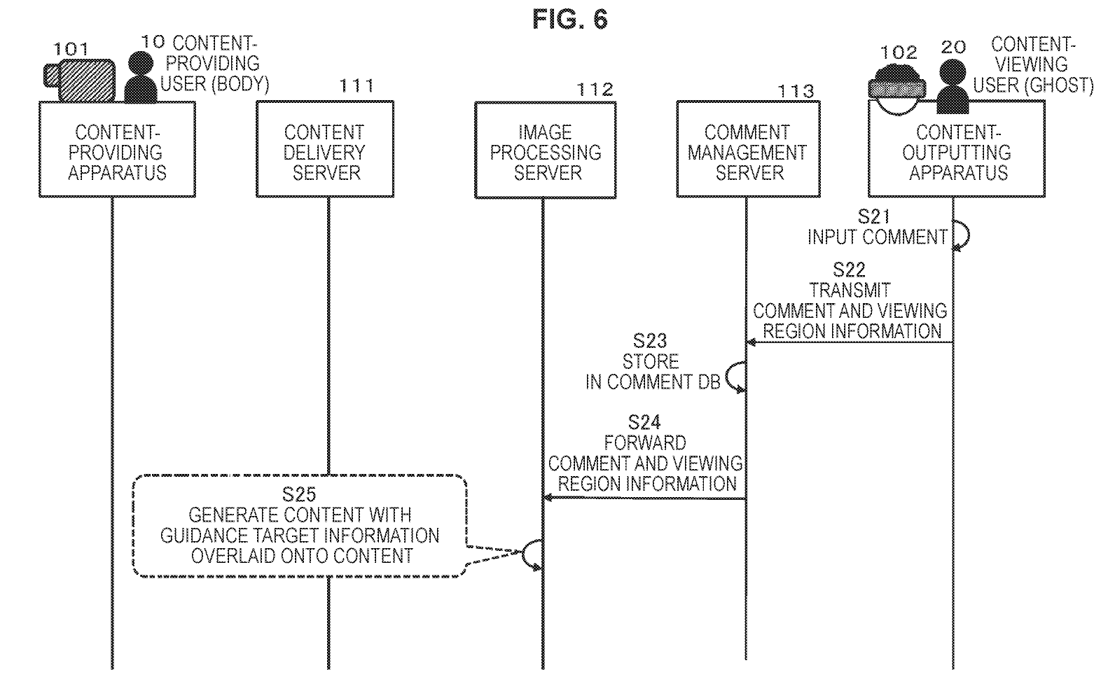

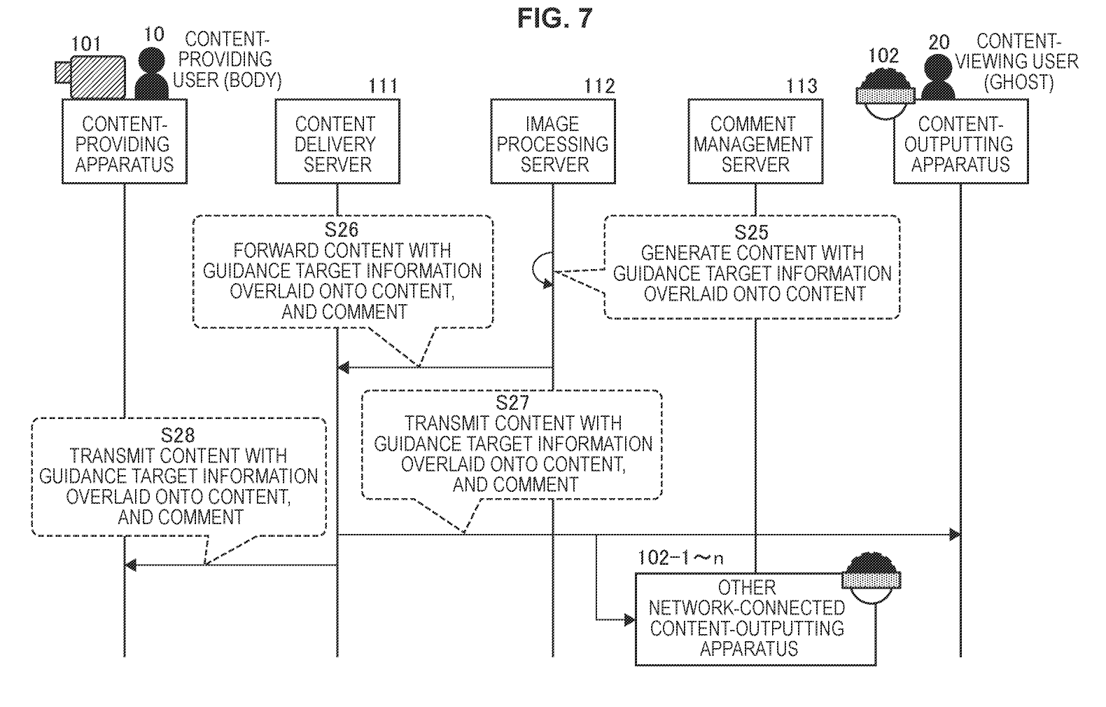

The sequences illustrated in FIGS. 6 and 7 will be referenced to describe a processing sequence in the case of displaying comments by content-viewing users overlaid onto the content. Similarly to FIG. 4 described earlier, FIGS. 6 and 7 illustrate, from the left, the content-providing apparatus 101, the content delivery server 111, the image processing server 112, the comment management server 113, and the content-outputting apparatus 102 illustrated in FIG. 1. Each of these elements performs a communication process over the network 105.

Note that, before the process in step S21 illustrated in FIG. 6, it is assumed that the processes following the sequence described with reference to FIG. 4 already have been executed, and the free viewpoint video content illustrated in FIG. 5, for example, is being displayed on the content-outputting apparatus 102 and is being viewed by the content-viewing user 20. The delivered content of the content delivery server 111 may be either real-time content captured by the content-providing apparatus 101, or already-captured content stored in a content database. Hereinafter, the processes in each step of the sequence illustrated in FIGS. 6 and 7 will be described successively.

### (Step S21)

In step S21, the content-viewing user 20 inputs a comment. The comment is input by speech input, or by manual input through a keyboard or the like, for example. When the content-viewing user 20 posts the comment, the playback of the content displayed by the content-outputting apparatus 102 of the content-viewing user 20 may also be paused. With this arrangement, the content-viewing user 20 is able to specify in detail the annotation target to which to attach the comment. In addition, the content-viewing user 20 may also be made to select between an annotation comment or a general comment at the time of posting, and be able to make comments in general without specifying a specific field of view.

### (Step S22)

Next, in step S22, the content-outputting apparatus 102 adds display image region information about the content-outputting apparatus 102 during comment input, or in other words, viewing region information about the content-viewing user 20 during comment input, to the comment input from the content-viewing user 20 as additional information, and transmits to the comment management server 113.

Otherwise, for example, an ID of the content-viewing user 20 who input the comment or an ID of the content-outputting apparatus 102, and comment input date and time information is added as attribute data corresponding to the comment.

Note that the viewing region information about the content-viewing user 20 during comment input specifically includes the following information, for example.

(1) Coordinate information indicating the displayed image region of the content-outputting apparatus 102 during comment input,

(2) Head direction or gaze direction information about the content-viewing user 20 during comment input, and

(3) Image parameters (such as field of view, zoom factor, and display mode) that prescribe the displayed image region of the content-outputting apparatus 102 during comment input.

Note that the image parameters indicated in (3) above may be computed on the content-outputting apparatus 102 side, or image parameters transmitted together with content from the content-providing apparatus 101 may be used.

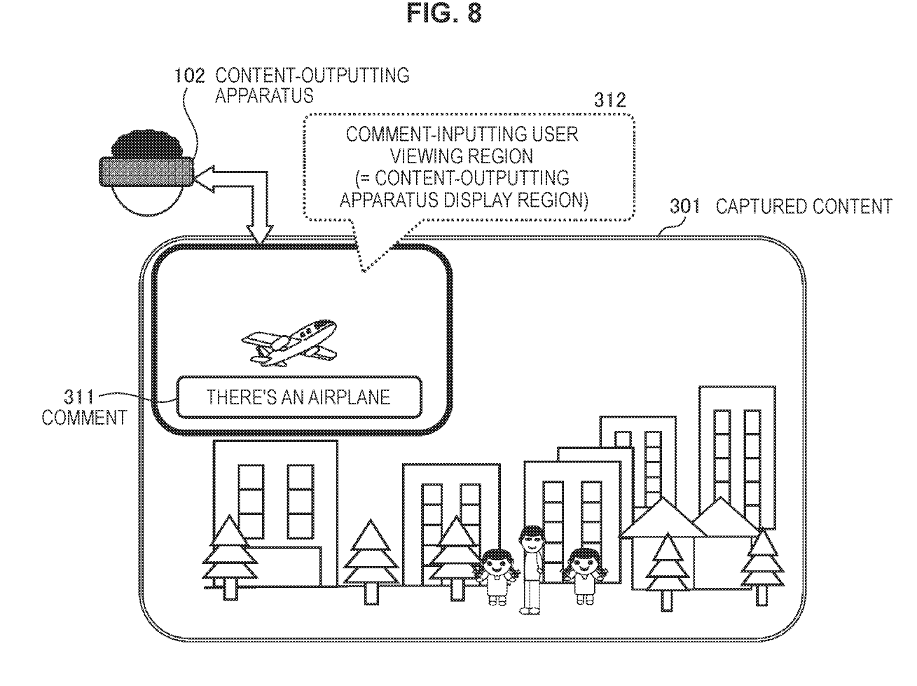

Referring to FIG. 8, a specific example of a comment by the content-viewing user 20 and viewing region information about the content-viewing user 20 during comment input will be described. The captured content 301 illustrated in FIG. 8 is an image (free viewpoint video) captured by the content-providing apparatus 101. The content-viewing user 20 views an image of a partial region of the captured content 301 displayed on the content-outputting apparatus 102, and inputs a comment with respect to the image inside the viewing region.

FIG. 8 illustrates an example in which the comment “There's an airplane” is input as a comment 311 by the content-viewing user 20. The viewing region of the content-viewing user 20 during comment input, or in other words, the image region being displayed on the content-outputting apparatus 102, is the comment-inputting user viewing region 312 illustrated in the diagram, and is the region illustrated by the bold frame in the diagram.

The comment-inputting user viewing region 312 illustrated in the diagram is the image region being displayed on the content-outputting apparatus 102 being used by the content-viewing user 20 who executed the comment input. Information indicating the comment-inputting user viewing region 312, specifically the coordinate information and the like described in (1) to (3) above, for example, is transmitted together with the comment to the comment management server 113.

### (Steps S23 and S24)

Next, in step S23, the comment management server 113 stores the comment and attached data transmitted by the content-outputting apparatus 102, or in other words, received data including the displayed image region information about the content-outputting apparatus 102 during comment input, in the comment database 114. In step S24, the comment management server 113 forwards the received data to the image processing server 112.

### (Step S25)

Next, in step S25, the image processing server 112 sets the displayed image region information attached to the comment received from the comment management server 113, or in other words, the image region that the content-viewing user 20 who input the comment was viewing during comment input, as additional information about the comment as guidance target information with respect to the captured content 301 of the content-providing apparatus 101.

### (Steps S26 to S28)

The processes in the following steps S26 to S28 will be described with reference to FIG. 7. Note that in FIG. 7, to make the flow of processes easier to understand, the process in step S25 illustrated in FIG. 6 is duplicated.

First, in step S26, the image processing server 112 forwards the content overlaid with the guidance target information generated in step S25, together with the comment, to the content delivery server 111. In steps S27 and S28, the content delivery server 111 transmits the content including the guidance target information and the comment received from the image processing server to the numerous content-outputting apparatus 102 connected to the network, and also to the content-providing apparatus 101.

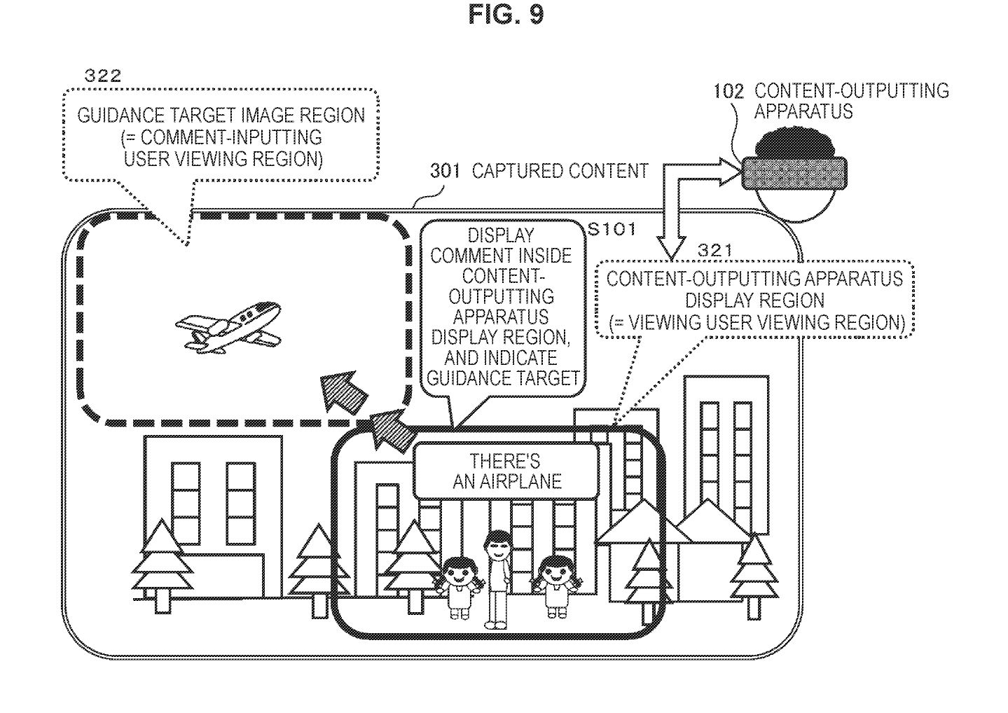

A specific example of the content delivered by the content delivery server 111, that is, the content overlaid with the comment (comment information) and the guidance target information, will be described with reference to FIG. 9. The comment information displayed in the second viewing region may be an image summarizing the comment which is input in the first viewing region. Please note that the comment may be converted into a picture image including less or no text images through the summarization. In addition, the summarization is performed on the basis of arrangement of objects displayed in the second viewing region. For example, the comment, which is to be displayed in the second viewing region, is summarized to avoid being overlaid to a specific object (s), e.g. a person, FIG. 9 is a diagram explaining a displayed image on the content-outputting apparatus 102 of another content-viewing user who is not the viewing user who input the comment.

The captured content 301 illustrated in FIG. 9 is an image (free viewpoint video) captured by the content-providing apparatus 101. The content-viewing user 20 views an image of a partial region of the captured content 301 displayed on the content-outputting apparatus 102. The viewing region of the content-viewing user 20, or in other words, the image region being displayed on the content-outputting apparatus 102, is the content-outputting apparatus display region 321 illustrated in the diagram, and is the region illustrated by the bold frame in the diagram.

The content-outputting apparatus 102 displays the comment received from the content delivery server 111 inside the content-outputting apparatus display region 321. Additionally, guidance information that guides one to the guidance target is displayed on the basis of the guidance target information attached to the delivered content. In other words, guidance information that guides one to the guidance target image region 322 illustrated in FIG. 9, such as the arrows illustrated in the diagram, for example, is displayed pointing from the content-outputting apparatus display region 321 to the guidance target image region 322.

The content-viewing user 20 viewing the content-outputting apparatus display region 321 illustrated in FIG. 9 finds the guidance information, such as the arrows illustrated in the diagram, for example, and by following the arrows to change the direction of one's head or one's gaze, is able to see the image of the guidance target image region 322 illustrated in FIG. 9. In other words, the content-viewing user 20 becomes able to see the same image as the comment inputter.

Note that the guidance target information that prescribes the guidance target image region 322, as illustrated in step S28 of FIG. 7 described earlier, may also be transmitted to the content-providing apparatus 101, and may also be confirmed by the content-providing user 10.

Note that the example illustrated in FIG. 9 is an example in which one comment and the guidance target image region 322 corresponding to the comment are set. However, a configuration that sets numerous comments and numerous guidance target image regions corresponding to the comments is also possible. For example, in the case in which there are numerous comments, the content-outputting apparatus 102 displays a comment list on the content-outputting apparatus display region 321. That is, the comment list may be displayed in the second viewing region and include a plurality of different comments input by a viewer(s). When a viewer selects a single comment from the list, the content-outputting apparatus 102 may display information such as an arrow that guides the viewer to the guidance target corresponding to the selected comment. In addition, at least one comment included in the comment list may be deleted when at least part of the second viewing region and at least part of the first viewing region, where the at least one comment is displayed, are overlapped to each other.

Furthermore, a configuration may be taken in which actual direction information, such as direction information indicating “30 degrees to the left horizontally, 20 degrees up vertically”, for example, may be displayed together with the comment.

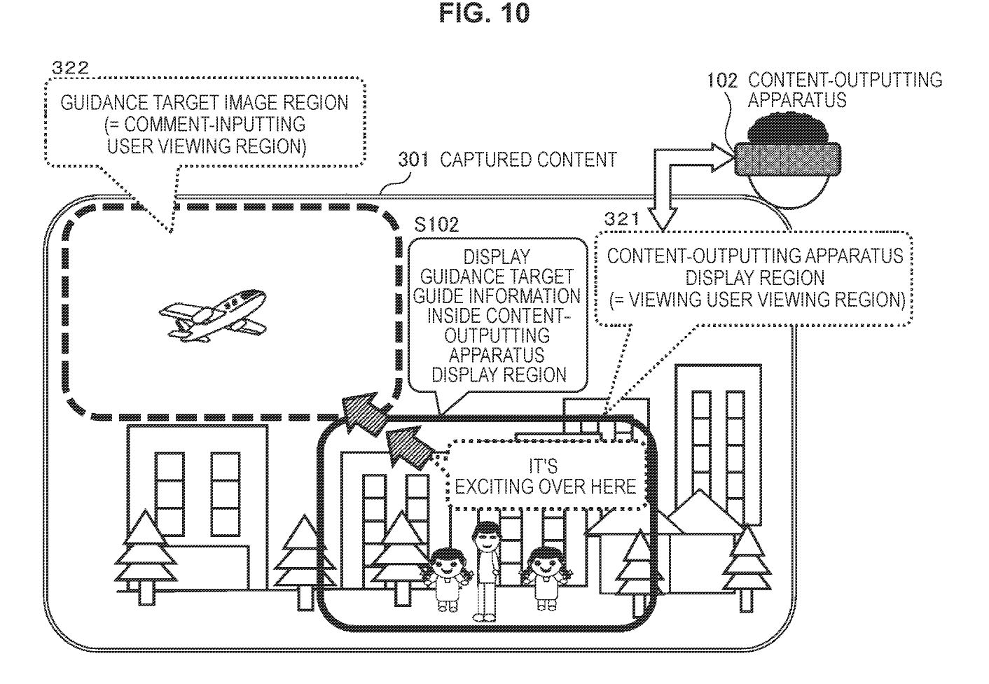

Furthermore, a configuration is also possible in which the image processing server 112 generates and transmits additional information other than the comment to each content-outputting apparatus 102, and each content-outputting apparatus 102 displays the additional information. For example, the image processing server 112 acquires viewing region information about numerous content-outputting apparatus displaying the same content, and analyzes the display region (field of view) and the like where numerous comments are being posted. Additionally, the image processing server 112 generates and provides a comment recommending the viewing of the image in the region as additional information to the many content-outputting apparatus 102. A specific example will be described with reference to FIG. 10.

Similarly to FIG. 9, the captured content 301 illustrated in FIG. 10 is an image (free viewpoint video) captured by the content-providing apparatus 101. The content-viewing user 20 views an image of a partial region of the captured content 301 displayed on the content-outputting apparatus 102. The viewing region of the content-viewing user 20, or in other words, the image region being displayed on the content-outputting apparatus 102, is the content-outputting apparatus display region 321 illustrated in the diagram, and is the region illustrated by the bold frame in the diagram.

In the content-outputting apparatus display region 321, the content-outputting apparatus 102 does not display the comment received from the content delivery server 111, but rather the additional information generated by the image processing server 112. Specifically, the content-outputting apparatus 102 displays the message “It's exciting over here” illustrated in the diagram as the additional information. The additional information generated by the image processing server 112 guides the user 20 to the display region where numerous comments are being posted.

The content-viewing user 20 viewing the content-outputting apparatus display region 321 illustrated in FIG. 10 finds the additional information, and by following the additional information to change the direction of one's head or one's gaze, is able to see the image of the image region of the guidance target image region 322 illustrated in FIG. 10. In other words, the content-viewing user 20 becomes able to see the same image as the comment inputter.

### [5. Configuration of Content-Outputting Apparatus Enabling Switching Between Comment-Input Enabled Mode and Comment-Input Disabled Mode]

Next, a configuration of the content-outputting apparatus enabling switching between a comment-input enabled mode and a comment-input disabled mode will be described.

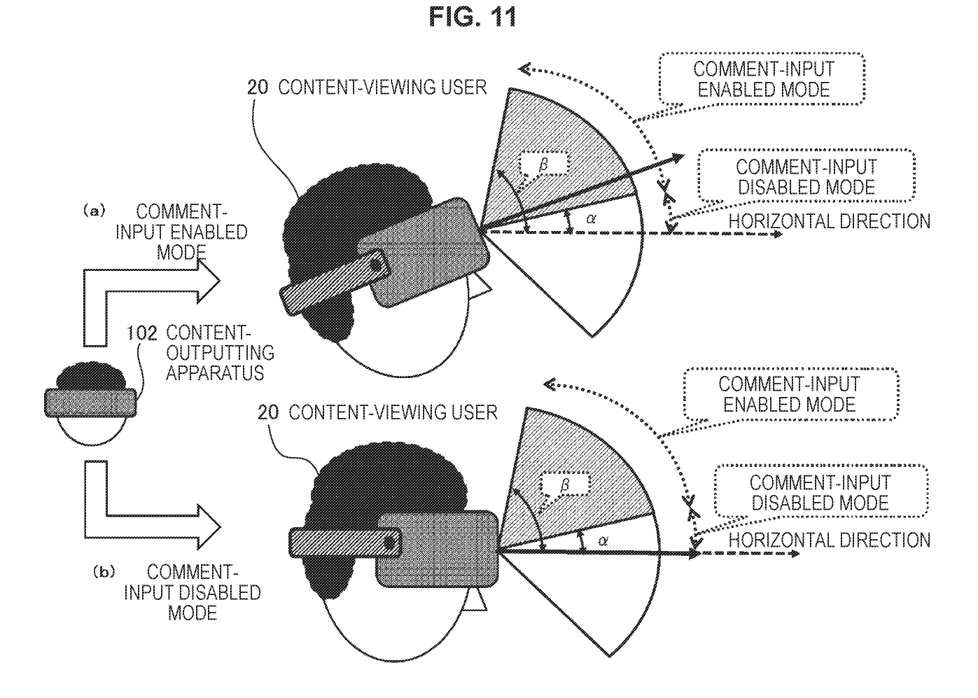

Referring to FIG. 11, a configuration of the content-outputting apparatus 102 enabling switching of the comment input mode will be described. As illustrated in FIG. 11, the content-outputting apparatus 102 has a configuration enabling switching between a comment-input enabled mode and a comment-input disabled mode.

As illustrated in the drawing, if the content-viewing user 20 who wears the content-outputting apparatus 102 and views the displayed content on the content-outputting apparatus 102 watches the content with one's gaze pointed in a diagonally upward direction (the range of angles from a to f in the upward direction from the horizontal direction), the comment-input enabled mode is set, which enables the input of comments. On the other hand, if the content-viewing user 20 watches the content with one's gaze pointed nearly horizontally (the range of angles from 0 to a in the upward direction from the horizontal direction), the comment-input disabled mode is set, which disables (limits) the input of comments. That is, a display of the comment input by the content-viewing user 20 (the first user) may be allowed in accordance with a first gaze direction of the content-viewing user 20. On the other hand, the display of the comment input by the content-viewing user 20 may be limited in accordance with a second gaze direction of the content-viewing user 20. In other words, a validity of an input comment may be determined in accordance with a gaze direction of the content-viewing user 20.

For example, in the case in which comments are input by the user's speech, and the content-outputting apparatus 102 is set to the comment-input enabled mode, user speech input through a microphone is recognized as a comment, and the comment is transmitted to the comment management server 113 over the network 105. Note that after recognizing user speech as a comment, the content-outputting apparatus 102 may also cause the user to specify an annotation target to which to attach the comment, in accordance with the gaze direction.

On the other hand, in the case in which the content-outputting apparatus 102 is set to the comment-input disabled mode, user speech input through the microphone is not recognized as a comment, and a process of transmitting a comment to the comment management server 113 over the network 105 is not performed. In other words, in this mode, user speech is recognized as a monologue, and is not processed as a comment.

The mode change is executed by the control unit when detection information is input from a sensor provided in the content-outputting apparatus 102. For example, as described earlier, the sensors that perform the head tracking process using a gyro or the like, or perform gaze detection using a pupil-corneal reflection method, are applied to detect the direction of the head or the gaze direction, and this detection information is used to switch the mode.

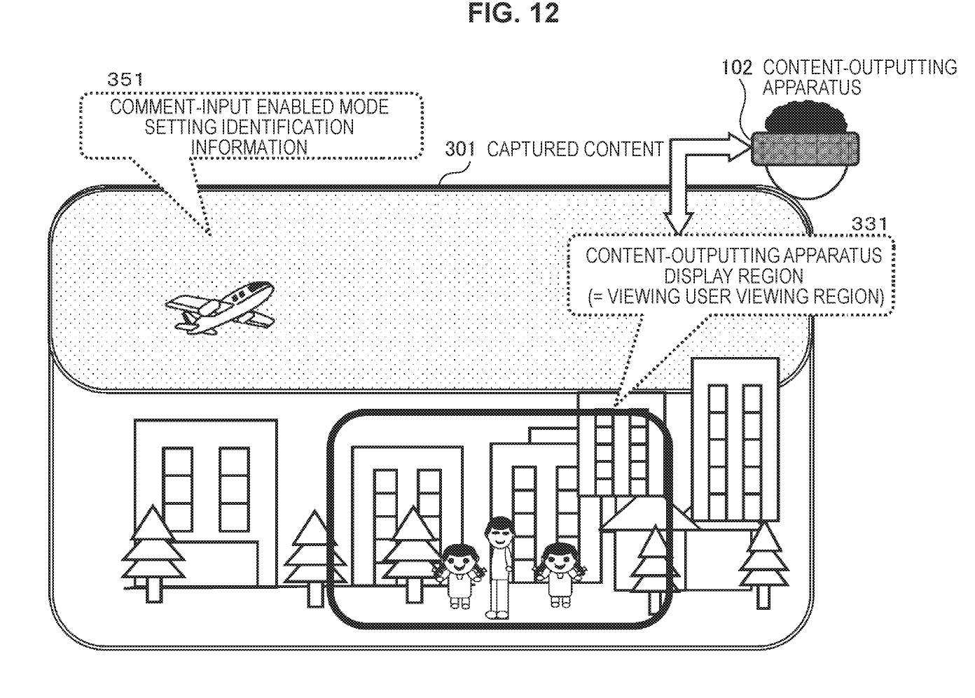

Note that to enable the content-viewing user 20 viewing the content-outputting apparatus 102 to recognize the set mode, it is preferable to take a configuration that displays information enabling the set mode to be discerned on the display unit of the content-outputting apparatus 102. A specific example will be described with reference to FIG. 12 and subsequent drawings.

The captured content 301 illustrated in FIG. 12 is an image (free viewpoint video) captured by the content-providing apparatus 101. The content-viewing user 20 views an image of a partial region of the captured content 301 displayed on the content-outputting apparatus 102. The viewing region of the content-viewing user 20, or in other words, the image region being displayed on the content-outputting apparatus 102, is the content-outputting apparatus display region 331 illustrated in the diagram.

As illustrated in FIG. 12, in the upper region of the captured content 301, comment-input enabled mode setting identification information 351 is displayed. In the example illustrated in FIG. 12, the content-outputting apparatus display region 331 is outside of the comment-input enabled mode setting identification information 351, and the mode is the comment-input disabled mode.

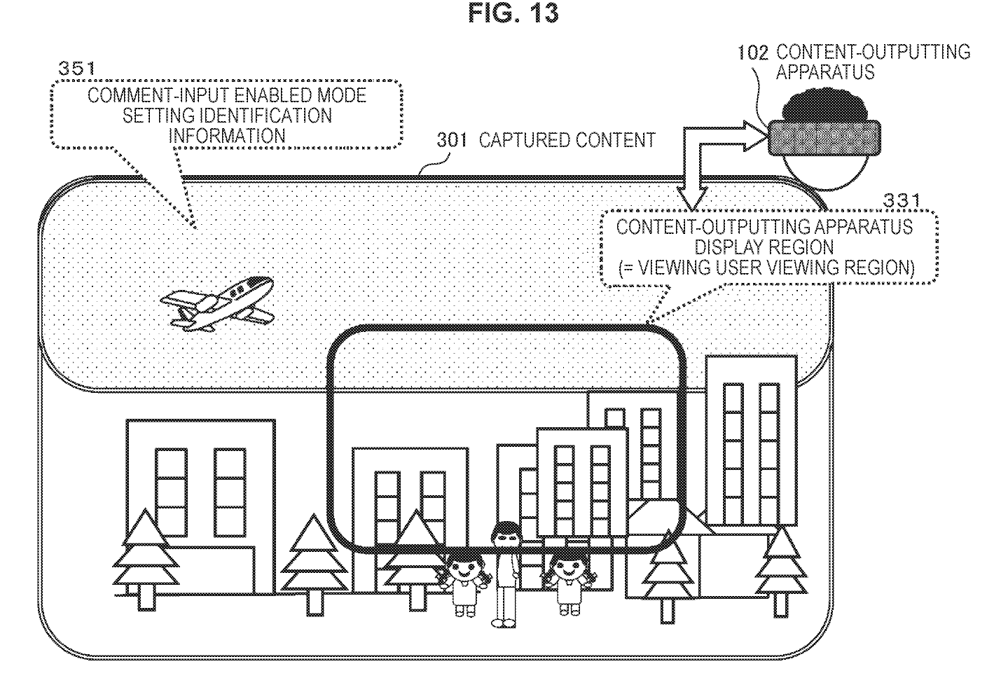

On the other hand, the example illustrated in FIG. 13 is an example in which part of the comment-input enabled mode setting identification information 351 is included in the content-outputting apparatus display region 331. By this display, the content-viewing user 20 becomes able to discern whether the content-outputting apparatus 102 is set to the comment-input enabled mode or set to the comment-input disabled mode.

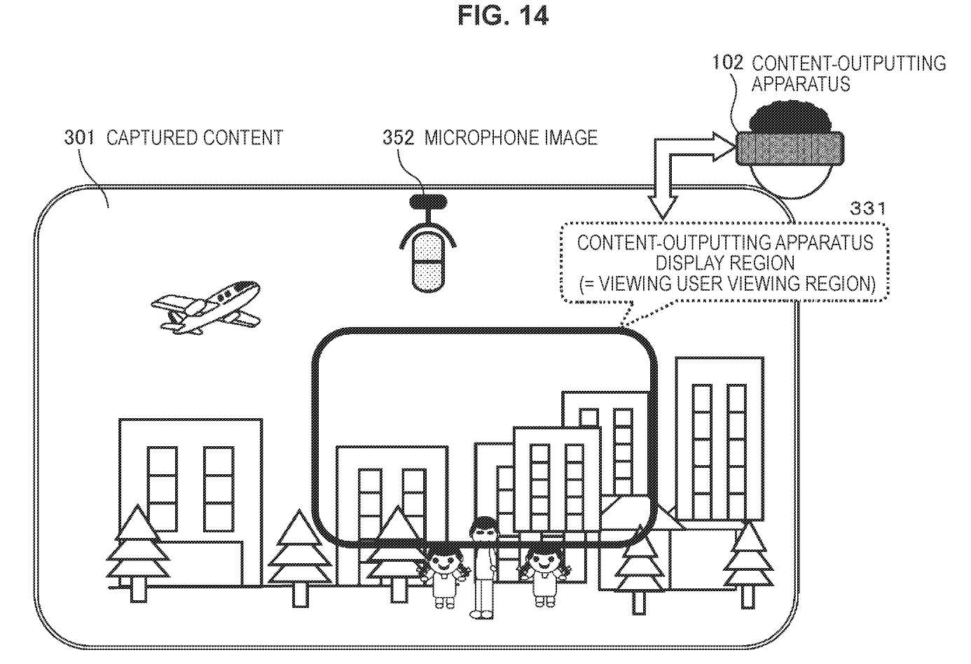

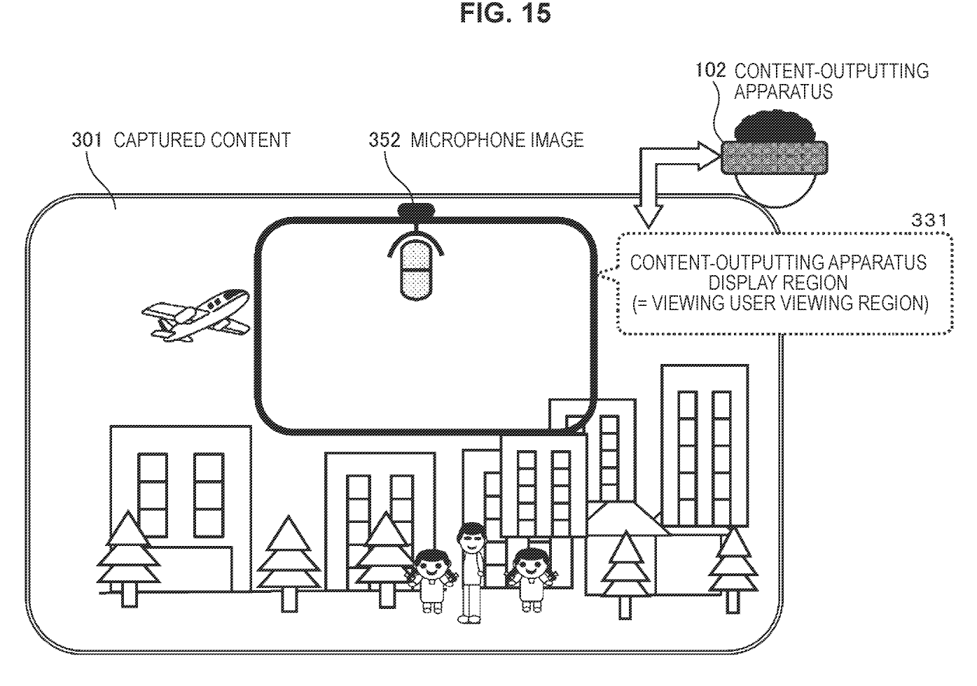

Furthermore, FIG. 14 is an example of using a microphone image 352 as comment-input enabled mode setting identification information. In the example illustrated in FIG. 14, the microphone image 352 is not displayed in the content-outputting apparatus display region 331, and the mode is the comment-input disabled mode. On the other hand, the example illustrated in FIG. 15 is an example in which the microphone image 352 is displayed as the comment-input enabled mode setting identification information in the content-outputting apparatus display region 331. By this display, the content-viewing user 20 becomes able to discern whether the content-outputting apparatus 102 is set to the comment-input enabled mode or set to the comment-input disabled mode.

Note that control may be performed so that, for example, in the case in which only part of the microphone image 352 is included in the content-outputting apparatus display region 331, the speech input gain is lowered and set to make the speech sound far away, whereas in the case in which all of the microphone image 352 is included in the content-outputting apparatus display region 331, the gain setting is raised and set to make the speech sound close by.

Note that in the example described above, an example of the content-outputting apparatus 102 switching the mode between the comment-input enabled mode and the comment-input disabled mode is described. However, the configuration is not limited to such a processing configuration. For example, a configuration may be taken in which, for example, all comments input into the content-outputting apparatus 102 and gaze direction information about the comment inputter during comment input is transmitted from the content-outputting apparatus 102 to the comment management server 113. On the comment management server 113, the mode in which the comments were input is determined, and only comments input in the comment-input enabled mode are stored in the comment database 114 as valid comments.

### [6. Exemplary Hardware Configuration of Information Processing Apparatus]

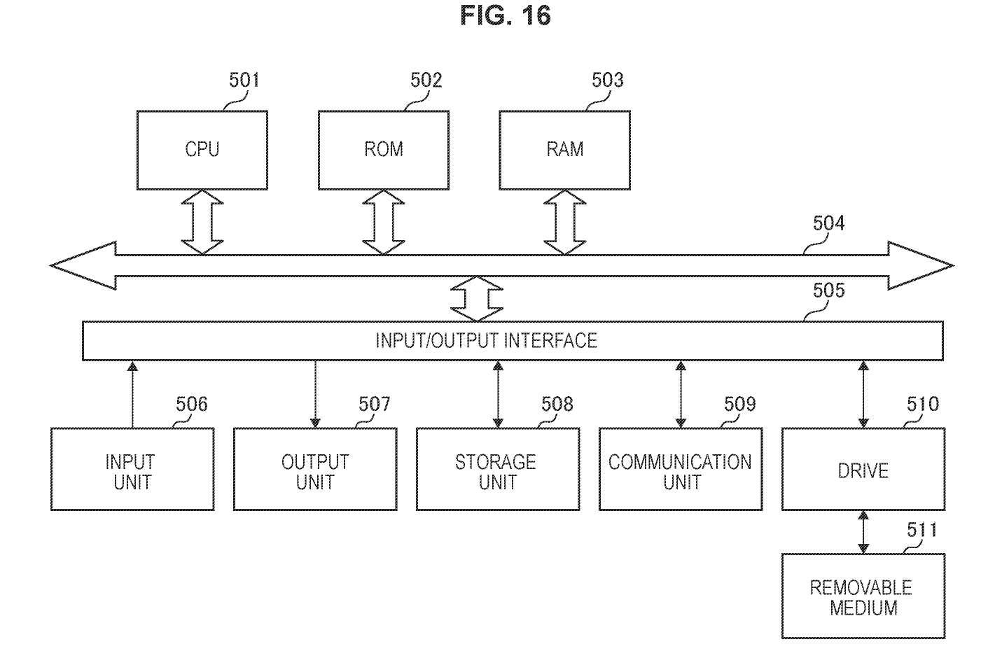

Next, an exemplary hardware configuration of the information processing apparatus will be described with reference to FIG. 16. The hardware described with reference to FIG. 16 is an example of a hardware configuration of the content-providing apparatus 101, an information processing apparatus included in the content-outputting apparatus 102, and additionally an information processing apparatus included in the content delivery server 111, the image processing server 112, and the comment management server 113, which are included in the information processing system described earlier with reference to FIG. 1.

A central processing unit (CPU) 501 functions as a control unit and a data processing unit that executes various processes in accordance with a program stored in read-only memory (ROM) 502 or a storage unit 508. For example, processes following the sequences described in the embodiment described above are executed. Random access memory (RAM) 503 stores programs executed by the CPU 501, data, and the like. The CPU 501, ROM 502, and RAM 503 are interconnected by a bus 504.

The CPU 501 is connected to an input/output interface 505 via the bus 504. Connected to the input/output interface 505 are an input unit 506, which includes various switches, a keyboard, a mouse, a microphone, sensors, and the like, and an output unit 507, which includes a display, speakers, and the like. The CPU 501 executes various processes in response to commands input from the input unit 506, and outputs processing results to the output unit 507, for example. Note that in the case of the content-providing apparatus 101, the input unit 506 includes an imaging unit.

A storage unit 508 connected to the input/output interface 505 includes a hard disk or the like, for example, and stores programs executed by the CPU 501 and various data. A communication unit 509 functions as a transmitting/receiving unit for Wi-Fi communication, Bluetooth® (BT) communication, or some other data communication via a network such as the Internet or a local area network, and communicates with external apparatus.

A drive 510 connected to the input/output interface 505 drives a removable medium 511 such as a magnetic disk, an optical disc, a magneto-optical disc, or semiconductor memory such as a memory card, and executes the recording or reading of data.

### [7. Summary of Configuration According to Embodiment of Present Disclosure]

The foregoing thus provides a detailed explanation of embodiments of the present disclosure with reference to specific embodiments. However, it is obvious that persons skilled in the art may make modifications and substitutions to these embodiments without departing from the gist of the present disclosure. In other words, the present disclosure has been disclosed by way of example, and should not be interpreted in a limited manner. The gist of the present disclosure should be determined in consideration of the claims.

Additionally, the present technology may also be configured as below.

(1) An information processing apparatus including:

a data processing unit configured to control a display of content delivered over a network; and

a control unit configured to control an output apparatus configured to display at least a part of the content, in which

the data processing unit, on a basis of a first viewing region of a first user when the first user inputs a comment with respect to the delivered content, sets guidance information that guides, to the first viewing region, a second user viewing a second viewing region of the delivered content different from the first viewing region, the guidance information being set in the second viewing region, and

the control unit controls the output apparatus of the second user to display the second viewing region in which the guidance information is set.

(2) The information processing apparatus according to (1), in which

the guidance information includes an indicator that indicates a direction to the first viewing region.

(3) The information processing apparatus according to (2), in which

the indicator has an arrow-shape.

(4) The information processing apparatus according to (2) or (3), in which

the indicator includes message information.

(5) The information processing apparatus according to any one of (1) to (4), in which

the data processing unit is configured to set comment information related to the comment of the first user together with the guidance information in the second viewing region.

(6) The information processing apparatus according to any one of (1) to (5), in which

the data processing unit is configured to
set, in the second viewing region, a comment list including a plurality of different comments input by the first user, and
set the guidance information that guides the second user to the first viewing region corresponding to a comment selected from the comment list by the second user.
   (7) The information processing apparatus according to any one of (1) to (6), in which

the delivered content is free viewpoint video content or omnidirectional video content in which a display region of the output apparatus is changed in accordance with a gaze direction of the second user.

(8) The information processing apparatus according to any one of (1) to (7), in which

the data processing unit is configured to
allow a display of the comment input by the first user in accordance with a first gaze direction of the first user, and
limit the display of the comment input by the first user in accordance with a second gaze direction of the first user, the second gaze direction being different from the first gaze direction.
   (9) The information processing apparatus according to (8), in which

the data processing unit is configured to
execute a mode switch between a comment-input enabled mode and a comment-input disabled mode, in accordance with the gaze direction of the first user, and
allow only the display of a comment input during a period of the comment-input enabled mode.
   (10) The information processing apparatus according to (9), in which

the network-delivered content is free viewpoint video content or omnidirectional video content in which the first viewing region is changed in accordance with the gaze direction of the first user, and

the data processing unit is configured to execute the mode switch between the comment-input enabled mode and the comment-input disabled mode, in accordance with a change of the first viewing region.

(11) The information processing apparatus according to (9) or (10), in which

the control unit is configured to control the output apparatus of the first user to display mode identification information enabling identification of a mode setting state of the comment-input enabled mode and the comment-input disabled mode.

(12) The information processing apparatus according to (11), in which

the mode identification information includes a microphone image, and

the control unit controls the output apparatus of the first user to display the microphone image on the display unit in the comment-input enabled mode, and not to display the microphone image on the display unit in the comment-input disabled mode.

(13) The information processing apparatus according to any one of (8) to (12), in which

the control unit is configured to transmit a signal related to the allowed display of the comment to an output apparatus of the second user over the network.

(14) The information processing apparatus according to any one of (8) to (13), in which

the first gaze direction is a more upward direction than the second gaze direction.

(15) An information processing method including:

controlling a display of content delivered over a network;

controlling an output apparatus configured to display at least a part of the content;

setting, on a basis of a viewing region indicating a first viewing region of a first user when the first user inputs a comment with respect to the delivered content, guidance information that guides, to the first viewing region, a second user viewing a second viewing region of the delivered content different from the first viewing region, the guidance information being set in the second viewing region; and

controlling the output apparatus of the second user to display the second viewing region in which the guidance information is set.

(16) A storage medium containing a program that causes information processing to be executed in an information processing apparatus,

the program including:

an instruction of controlling an output apparatus configured to display at least a part of content delivered over a network;

an instruction of setting, on a basis of a viewing region indicating a first viewing region of a first user when the first user inputs a comment with respect to the delivered content, guidance information that guides, to the first viewing region, a second user viewing a second viewing region of the delivered content different from the first viewing region, the guidance information being set in the second viewing region; and

an instruction of controlling the output apparatus of the second user to display the second viewing region in which the guidance information is set.

Alternatively, the present technology may also be configured as below.

(1) An information processing apparatus including:

a data processing unit that controls the display of network-delivered content, in which

the data processing unit is configured to

acquire comment inputter viewing region information that indicates a viewing region when a comment-inputting user inputs a comment, and

display, on the basis of the comment inputter viewing region information, guidance information for guiding one to the viewing region of the comment-inputting user, the guidance information being overlaid onto content.

(2) The information processing apparatus according to (1), in which

the guidance information

is an arrow indicating the direction of the viewing region of the comment-inputting user.

(3) The information processing apparatus according to (1), in which

the guidance information

is a message for guiding one to the viewing region of the comment-inputting user.

(4) The information processing apparatus according to any of (1) to (3), in which

the data processing unit is configured to

display the comment of the comment-inputting user, together with the guidance information, overlaid onto the content.

(5) The information processing apparatus according to any of (1) to (4), in which the data processing unit is configured to

display a comment list of a plurality of different comments overlaid onto the content, and

display guidance information that guides one to the viewing region of the comment-inputting user corresponding to a comment selected from the comment list by the content-viewing user.

(6) The information processing apparatus according to any of (1) to (5), in which

the network-delivered content is free viewpoint video content, and

is content in which a display region is changed in accordance with a gaze direction of the content-viewing user.

(7) An information processing apparatus including:

a data processing unit that executes a content-viewing user comment process with respect to content displayed on a display unit, in which

the data processing unit is configured to

determine a validity of an input comment in accordance with a gaze direction of the content-viewing user.

(8) The information processing apparatus according to (7), in which

the data processing unit is configured to

execute a mode switch between a comment-input enabled mode and a comment-input disabled mode, in accordance with the gaze direction of the content-viewing user, and

perform a process of determining only a comment input during a comment-input enabled mode period to be a valid comment.

(9) The information processing apparatus according to (8), in which

the data processing unit is configured to

perform a process of transmitting a comment input during the comment-input enabled mode period over a network, thereby enabling confirmation by another content-viewing user.

(10) The information processing apparatus according to either (8) or (9), in which

the network-delivered content is free viewpoint video content, and

is content in which a display region is changed in accordance with a gaze direction of the content-viewing user, and

the mode switch between the comment-input enabled mode and the comment-input disabled mode is configured to be executed in accordance with a change of the display region.

(11) The information processing apparatus according to any of (8) to (10), in which

the data processing unit is configured to

display, on the display unit, mode identification information enabling identification of a mode setting state of the comment-input enabled mode and the comment-input disabled mode.

(12) The information processing apparatus according to (11), in which

the data processing unit is configured to

use a microphone image as the mode identification information, and

controls the display to display the microphone image on the display unit in the comment-input enabled mode, and not to display the microphone image on the display unit in the comment-input disabled mode.

(13) An information processing method executed in an information processing apparatus,

the information processing apparatus including

a data processing unit that controls the display of network-delivered content, in which

the data processing unit is configured to

acquire comment inputter viewing region information that indicates a viewing region when a comment-inputting user inputs a comment, and

display, on the basis of the comment inputter viewing region information, guidance information for guiding one to the viewing region of the comment-inputting user, the guidance information being overlaid onto content.

(14) An information processing method executed in an information processing apparatus,

the information processing apparatus including

a data processing unit that executes a content-viewing user comment process with respect to content displayed on a display unit, in which

the data processing unit is configured to

determine the validity of an input comment in accordance with a gaze direction of the content-viewing user.

(15) A program causing information processing to be executed in an information processing apparatus,

the information processing apparatus including

a data processing unit that controls the display of network-delivered content, in which

the program causes the data processing unit to execute

a process of acquiring comment inputter viewing region information that indicates a viewing region when a comment-inputting user inputs a comment, and

a process of displaying, on the basis of the comment inputter viewing region information, guidance information for guiding one to the viewing region of the comment-inputting user, the guidance information being overlaid onto content.

(16) A program causing information processing to be executed in an information processing apparatus,

the information processing apparatus including

a data processing unit that executes a content-viewing user comment process with respect to content displayed on a display unit, in which

the program causes the data processing unit to

determine the validity of an input comment in accordance with a gaze direction of the content-viewing user.

In addition, it is possible to execute the series of processes described in this specification by hardware, by software, or by a compound configuration of both. In the case of executing processes by software, a program stating a processing sequence may be installed onto memory in a computer built into special-purpose hardware and executed, or alternatively, the program may be installed and executed on a general-purpose computer capable of executed various types of processes. For example, the program may be prerecorded onto a recording medium. Besides installing the program onto a computer from a recording medium, the program may also be received via a network such as a local area network (LAN) or the Internet, and installed onto a built-in recording medium such as a hard disk.

Note that the various processes described in the specification not only may be executed in a time series in the order described, but may also be executed in parallel or individually according to the processing performance of the device executing the process, or as needed. Also, in this specification, the term “system” refers to a logical aggregate configuration of multiple devices, and the respective devices of the configuration are not limited to being inside the same housing.

### INDUSTRIAL APPLICABILITY

As described above, according to the configuration of an embodiment of the present disclosure, a configuration may be realized in which guidance information for guiding one to a viewing region of a comment-inputting user is displayed overlaid onto content, thereby enabling many content-viewing users to view a specific image region. Specifically, for example, a data processing unit that controls the display of network-delivered content is included. The data processing unit acquires comment inputter viewing region information that indicates a viewing region from when the comment-inputting user input a comment. On the basis of the comment inputter viewing region information, the data processing unit displays guidance information for guiding one to the viewing region of the comment-inputting user, overlaid onto the content. The guidance information is an arrow indicating the direction of the viewing region of the comment-inputting user, or an indicator (notification display) such as a message. The indicator may include a thumbnail indicating the viewing region of the comment-inputting user. Furthermore, it is possible to switch the mode of comment input between an enabled mode and a disabled mode. According to the present configuration, a configuration may be realized in which guidance information for guiding one to a viewing region of a comment-inputting user is displayed overlaid onto content, thereby enabling many content-viewing users to view a specific image region.

What is claimed is:

1. An information processing apparatus comprising:
a data processing unit configured to control a display of content delivered over a network; and
a control unit configured to control an output apparatus configured to display at least a part of the content, wherein
the data processing unit, on a basis of a first viewing region of a first user when the first user inputs a comment with respect to the delivered content, sets guidance information that guides, to the first viewing region, a second user viewing a second viewing region of the delivered content different from the first viewing region, the guidance information being set in the second viewing region, and
the control unit controls the output apparatus of the second user to display the second viewing region in which the guidance information is set.

2. The information processing apparatus according to claim 1, wherein
the guidance information includes an indicator that indicates a direction to the first viewing region.

3. The information processing apparatus according to claim 2, wherein
the indicator has an arrow-shape.

4. The information processing apparatus according to claim 2, wherein
the indicator includes message information.

5. The information processing apparatus according to claim 1, wherein
the data processing unit is configured to set comment information related to the comment of the first user together with the guidance information in the second viewing region.

6. The information processing apparatus according to claim 1, wherein
the data processing unit is configured to
set, in the second viewing region, a comment list including a plurality of different comments input by the first user, and
set the guidance information that guides the second user to the first viewing region corresponding to a comment selected from the comment list by the second user.

7. The information processing apparatus according to claim 1, wherein
the delivered content is free viewpoint video content or omnidirectional video content in which a display region of the output apparatus is changed in accordance with a gaze direction of the second user.

8. The information processing apparatus according to claim 1, wherein
the data processing unit is configured to
allow a display of the comment input by the first user in accordance with a first gaze direction of the first user, and
limit the display of the comment input by the first user in accordance with a second gaze direction of the first user, the second gaze direction being different from the first gaze direction.

9. The information processing apparatus according to claim 8, wherein
the data processing unit is configured to
execute a mode switch between a comment-input enabled mode and a comment-input disabled mode, in accordance with the gaze direction of the first user, and
allow only the display of a comment input during a period of the comment-input enabled mode.

10. The information processing apparatus according to claim 9, wherein
the network-delivered content is free viewpoint video content or omnidirectional video content in which the first viewing region is changed in accordance with the gaze direction of the first user, and
the data processing unit is configured to execute the mode switch between the comment-input enabled mode and the comment-input disabled mode, in accordance with a change of the first viewing region.

11. The information processing apparatus according to claim 9, wherein
the control unit is configured to control the output apparatus of the first user to display mode identification information enabling identification of a mode setting state of the comment-input enabled mode and the comment-input disabled mode.

12. The information processing apparatus according to claim 11, wherein
the mode identification information includes a microphone image, and
the control unit controls the output apparatus of the first user to display the microphone image on the display unit in the comment-input enabled mode, and not to display the microphone image on the display unit in the comment-input disabled mode.

13. The information processing apparatus according to claim 8, wherein
the control unit is configured to transmit a signal related to the allowed display of the comment to an output apparatus of the second user over the network.

14. The information processing apparatus according to claim 8, wherein
the first gaze direction is a more upward direction than the second gaze direction.

15. An information processing method comprising:
controlling a display of content delivered over a network;
controlling an output apparatus configured to display at least a part of the content;
setting, on a basis of a viewing region indicating a first viewing region of a first user when the first user inputs a comment with respect to the delivered content, guidance information that guides, to the first viewing region, a second user viewing a second viewing region of the delivered content different from the first viewing region, the guidance information being set in the second viewing region; and
controlling the output apparatus of the second user to display the second viewing region in which the guidance information is set.

16. A storage medium containing a program that causes information processing to be executed in an information processing apparatus,
the program comprising:
an instruction of controlling an output apparatus configured to display at least a part of content delivered over a network:
an instruction of setting, on a basis of a viewing region indicating a first viewing region of a first user when the first user inputs a comment with respect to the delivered content, guidance information that guides, to the first viewing region, a second user viewing a second viewing region of the delivered content different from the first viewing region, the guidance information being set in the second viewing region; and
an instruction of controlling the output apparatus of the second user to display the second viewing region in which the guidance information is set.
